(19) United States
(12) Patent Application Publication
(10) Pub. No.: US 2003/0205865 A1
(43) Pub. Date: Nov. 6, 2003

(54) Engine gasket

(75) Inventor: Allyn P. Bock, West Lafayette, IN (US)

Correspondence Address: Finnegan, Henderson, Farabow,, Garrett & Dunner, L.L.P., 1300 I Street, N.W., Washington, DC, 20005-3315, US

(73) Assignee: Caterpillar Inc.

(21) Appl. No.: 10/138,561

(22) Filed: May 6, 2002

(51) Int. Cl. F02F 11/00

(52) U.S. Cl. 277/591

(57) ABSTRACT

An engine gasket is provided. The gasket includes a main body having a first sealing surface, a second sealing surface, an inner edge, and an outer edge. The inner edge defines an opening through the main body between the first and second sealing surfaces. A protrusion extends from the main body. The protrusion has a preestablished configuration that is accessible after the first and second sealing surfaces are adapted for sealing therebetween.

### TECHNICAL FIELD

The present invention is directed to an engine gasket. More particularly, the present invention is directed to an engine manifold sealing gasket.

### BACKGROUND

Engines are commonly assembled from a number of separately manufactured parts. For example, an engine typically includes a cylinder head, an intake manifold, and an exhaust manifold, which are normally manufactured as separate components. These components are then assembled with the other necessary parts to produce an engine.

During operation of the engine, the intake manifold directs an intake air into one or more combustion chambers that are formed within the cylinder head. Fuel, such as diesel, gasoline, or natural gas, is mixed with the intake air. The fuel and air mixture is combusted to drive a piston housed within the combustion chamber. An exhaust gas resulting from the combustion is then forced from the cylinder head into the exhaust manifold. This exhaust gas may be treated to reduce the emissions in the gas, such as by an engine gas recirculation system. In addition, the exhausted gas may be used to drive a turbocharger that pre-charges the intake air.

Achieving consistent air flow to and from the engine is important for proper operation of the engine. To prevent leaks, sealing devices, such as gaskets, are typically placed between components that are joined together to define a passageway into or out of the engine. For example, gaskets may be placed between the cylinder head and the intake manifold and between the cylinder head and the exhaust manifold to prevent gases from leaking at the joints between the respective parts.

Gaskets may also be placed between other engine components to prevent gases from leaking from the engine. For example, an engine may be equipped with sensors or probes that monitor the operating conditions of the engine. These sensors and probes may be coupled with a cover plate that is engageable with the engine. A gasket may be disposed between the cover plate and the engine to form a seal and prevent gases from leaking from the engine.

During assembly, however, it may be difficult to properly position gaskets between the engine components. This difficulty arises, in large part, due to the cumbersome assembly process of two relatively large and/or heavy components. An improperly positioned gasket may interfere with the operation of the engine. If the gasket slips relative to the cylinder head and manifold during assembly, the gasket may result in a position where the gasket blocks the passageway between the components. Any such blockage in the passageway to or from the engine may interfere with the intake or exhaust process of the engine.

Accordingly, care must be taken during the assembly process to ensure that these gaskets are properly positioned. One approach to ensuring the proper positioning of gaskets is described in U.S. Pat. No. 6,328,313. In this approach, an adhesive is used to prevent the gasket from slipping during assembly. However, this adhesive may form a bond between the gasket and the cylinder head or manifold, thereby complicating the removal and replacement of the gasket during normal servicing. Thus, while the adhesive may simplify the assembly process, it may increase the complexity of the maintenance process.

The engine gasket of the present invention solves one or more of the problems set forth above.

### SUMMARY OF THE INVENTION

One aspect of the present invention is directed to an engine gasket. The gasket includes a main body having a first sealing surface, a second sealing surface, an inner edge, and an outer edge. The inner edge defines an opening through the main body between the first and second sealing surfaces. A protrusion extends from the main body. The protrusion has a preestablished configuration that is accessible after the first and second sealing surfaces are adapted for sealing therebetween.

In another aspect, the present invention is directed to a method of assembling an engine. A cylinder head having an outer surface, at least one intake passageway, and at least one exhaust passageway is provided. At least one of an intake manifold having a flange and an exhaust manifold having a flange is provided. At least one gasket having a protrusion is disposed between the cylinder head and the flange of the at least one of the intake manifold and the exhaust manifold. The protrusion has a preestablished configuration that is accessible after the at least one gasket is positioned between the cylinder head and the flange of the at least one of the intake manifold and the exhaust manifold. The flange of the at least one of the intake manifold and the exhaust manifold is secured to the cylinder head.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate exemplary embodiments of the invention and together with the description, serve to explain the principles of the invention. In the drawings:

FIG. 1 is a pictorial representation of an engine gasket in accordance with an exemplary embodiment of the present invention;

FIG. 2 is a diagrammatic and schematic representation of an engine in accordance with an exemplary embodiment of the present invention;

FIG. 3 is a sectional view of an engine gasket according to an exemplary embodiment of the present invention disposed between a cylinder head and a manifold flange; and

FIG. 4 is a pictorial representation of an engine, illustrating a cylinder head and an exhaust manifold.

### DETAILED DESCRIPTION

Reference will now be made in detail to exemplary embodiments of the invention, which are illustrated in the accompanying drawings. Wherever possible, the same reference numbers will be used throughout the drawings to refer to the same or like parts.

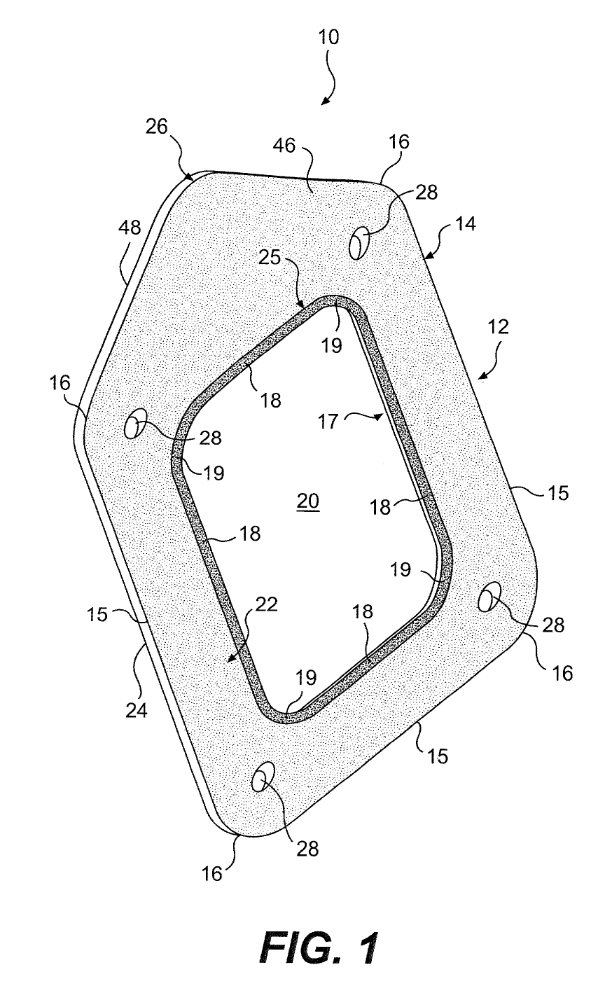

An exemplary embodiment of an engine gasket 10 is illustrated in FIG. 1. As shown, gasket 10 includes a main body 12. Main body 12 includes a first sealing surface 22 and a second sealing surface 24. Main body 12 may be constructed of any material readily apparent to one skilled in the art, such as, for example, a metallic or elastomeric material.

Main body 12 further includes an inner edge 17 that defines an opening 20. Opening 20 extends between first sealing surface 22 and second sealing surface 24. Inner edge 17 may include at least one linear segment 18. Inner edge 17 may further include a series of four linear segments 18 connected by a series of rounded corners 19. In this exemplary embodiment, opening 20 has a substantially rectangular shape. It should be understood, however, that inner edge 17 may define an opening 20 of any shape readily apparent to one skilled in the art as suitable for its intended purpose. For example, inner edge 17 may define a circular, semi-circular, or oval opening. In addition, inner edge 17 may include a combination of arcuate and linear sections.

As also shown in FIG. 1, a protective substance 25 may be disposed on inner edge 17 and along each of first and second sealing surfaces 22 and 24 adjacent inner edge 17. In certain circumstances, a high temperature fluid may be directed through opening 20 in main body 12. Protective substance 25 is applied to main body 12 adjacent inner edge 17 to protect main body 12 from damage caused by the high temperature fluid. Protective substance 25 may be a heat-sensitive multi-layer or composite sealing material. Examples of material used for the protective substance 25 include a soft metallic or non-metallic material, such as a mild steel, a nitrile rubber, a heat curable liquid silicone, a fluoroelastomer, a thermoplastic resin having a filler therein, or a graphite facing. In addition, the protective substance may be impregnated with a conventional temperature, oil and water resistant impregnate. Other suitable materials readily apparent to one skilled in the art may be used as the protective substance 25.

Main body 12 also includes an outer edge 14. Outer edge 14 may include at least one linear segment 15 that extends substantially parallel to one of linear segments 18 of inner edge 17. Outer edge 14 may further include three linear segments 15, each of which adjoin a rounded corner 16. Each of the three linear segments 15 extend substantially parallel to one of linear segments 18 of inner edge 17. In this exemplary embodiment, main body 12 has a substantially rectangular shape. It should be understood, however, that outer edge 14 may have any shape readily apparent to one skilled in the art as suitable for its intended purpose. For example, outer edge 14 may have a circular or oval shape. In addition, outer edge 14 may include a combination of arcuate and linear sections.

As further shown in FIG. 1, main body 12 may include a series of openings 28. Each opening 28 may be disposed adjacent a rounded corner 19 of inner edge 17. One skilled in the art will recognize that openings 28 may be placed in various other locations within main body 12 depending upon the particular application of gasket 10. In addition, one skilled in the art will recognize that openings 28 may be formed as slits or notches in outer edge 14.

As also illustrated in FIG. 1, gasket 10 includes a means for positioning the gasket, which may be a protrusion 26. Protrusion 26 includes a first surface 46 and a second surface 48. First surface 46 extends from first sealing surface 22 and second surface 48 extends from second sealing surface 24.

In the illustrated exemplary embodiment, protrusion 26 has a generally triangular shape and first and second surfaces 46 and 48 are disposed in substantially the same plane as first and second sealing surfaces 22 and 24, respectively. It should be understood, however, that protrusion 26 may have a variety of different configurations, such as, for example, rectangular, square, semi-circular, or any other shape readily apparent to one skilled in the art. In addition, first and second surfaces 46 and 48 of protrusion 26 may be disposed outside of the planes defined by first and second sealing surfaces 22 and 24.

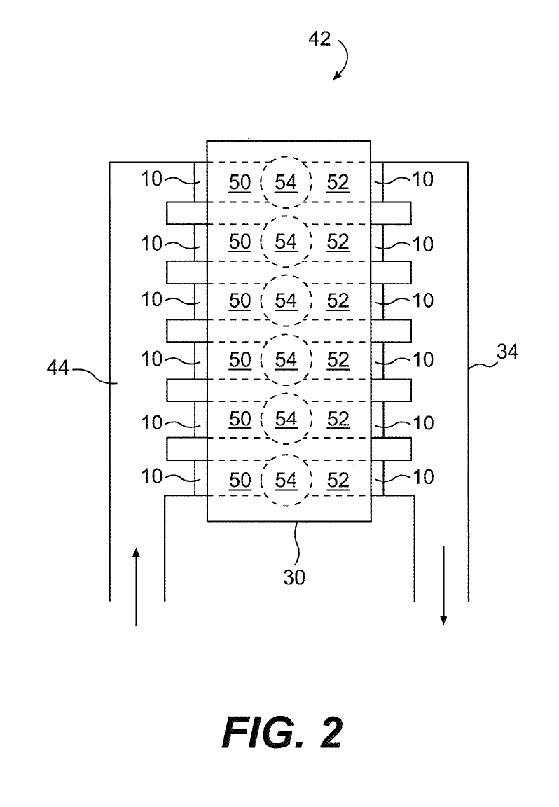

As illustrated in FIG. 2, gasket 10 is configured to be disposed between components of an engine 42. As a further alternative, gasket 10 may be used with a compressor. Gasket 10 may be disposed between any engine components where a fluid seal is required. For example, gasket 10 may be disposed between a cylinder head 30 and an intake manifold 44 or between cylinder head 30 and an exhaust manifold 34. In addition, gasket 10 may be disposed between an engine sensor or probe and the engine.

In the exemplary embodiment schematically illustrated in FIG. 2, cylinder head 30 of engine 42 includes a series of intake passageways 50. Each intake passageway 50 provides a passageway through cylinder head 30 to a combustion chamber 54. Cylinder head 30 further includes a series of exhaust passageways 52. Exhaust passageways 52 provide a passageway through cylinder head 30 from each combustion chamber 54.

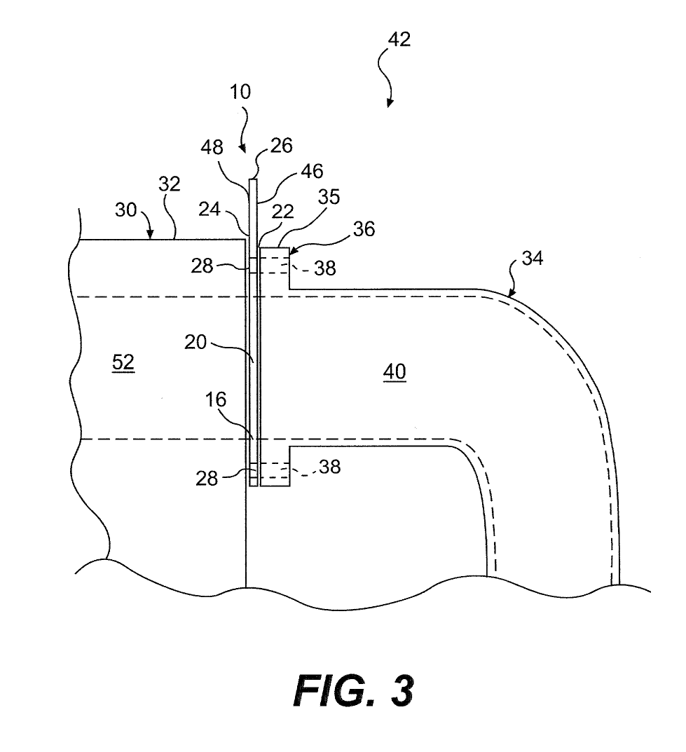

As shown in FIG. 3, protrusion 26 of gasket 10 extends past an outer surface 32 of cylinder head 30 and past an outer surface 35 of flange 36. Gasket 10 is properly positioned when opening 20 in main body 12 is aligned with exhaust passageway 52 and a corresponding passageway 40 in exhaust manifold 34. The extension of protrusion 26 also provides an obvious visual indication that a gasket is positioned between cylinder head 30 and the respective manifold flange.

As also shown in FIG. 2, intake manifold 44 and exhaust manifold 34 are engageable with cylinder head 30 of engine 42. Intake manifold 44 is engaged with cylinder head 30 to allow intake air flowing through intake manifold 44 to flow through intake passageways 50 to combustion chambers 54. Exhaust manifold 34 is engaged with cylinder head 30 to allow exhaust flowing from combustion chambers 54 through exhaust passageways 52 to enter exhaust manifold 34. It should be understood that intake manifold 44 and exhaust manifold 44 may have any configuration readily apparent to one skilled in the art.

A first series of gaskets 10 are disposed between intake manifold 44 and cylinder head 30 and are disposed adjacent each intake passageway 50. A second series of gaskets 10 are disposed between exhaust manifold 34 and cylinder head 30 and are disposed adjacent each exhaust passageway 52. Each gasket 10 forms a seal between cylinder head 30 and the respective manifold to prevent gases, such as air or exhaust, from leaking at the joints between cylinder head 30 and intake manifold 44 and from between cylinder head 30 and exhaust manifold 34.

As illustrated in FIG. 3, gasket 10 may be disposed between cylinder head 30 and a flange 36 on the respective manifold (illustrated as the exhaust manifold 34). First sealing surface 22 of main body 12 of gasket 10 engages flange 36 and second sealing surface 24 of main body 12 of gasket 10 engages cylinder head 30.

A series of fasteners (not shown) may be disposed in a pattern around exhaust passageway 52. The fasteners may be bolts that are engageable with corresponding holes in cylinder head 30. Openings 28 in main body 12 of gasket 10 are configured to receive the bolts. Similarly, flange 36 may include a series of openings 38 that are configured to receive the bolts. The engagement of the bolts with cylinder head 30 will clamp flange 36 to cylinder head 30.

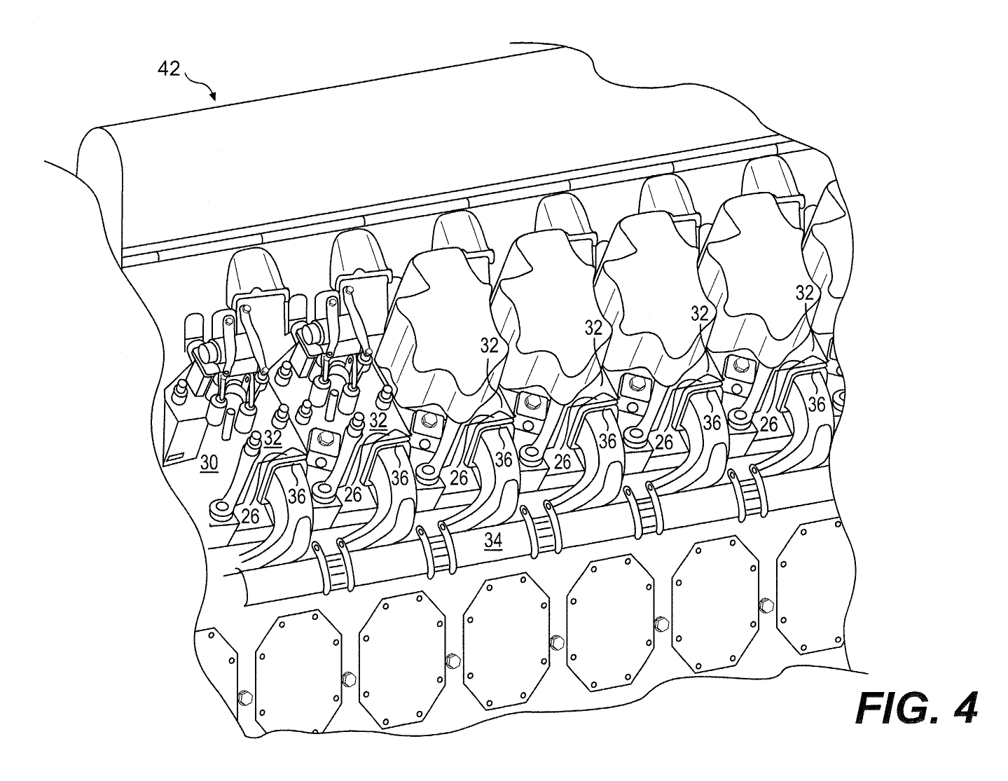

As shown in FIG. 4, a gasket 10 may be disposed between each flange 36 of exhaust manifold 34 and cylinder head 30. Protrusion 26 of each gasket 10 extends past outer surface 32 of cylinder head 30. When each flange 36 of exhaust manifold 34 is clamped to cylinder head 30 with the fasteners, each gasket 10 will help ensure that a seal is formed between each flange 36 and cylinder head 30 to prevent gas from escaping from its intended path. While FIG. 4 illustrates an internal combustion engine, it is contemplated that the gasket may be used with other types of engines or devices, such as a gas turbine or a compressor as well.

Industrial Applicability

As will be apparent from the foregoing description, the present invention provides a gasket 10 for use with an engine 42. A series of gaskets 10 according to the present invention may be disposed between the cylinder head 30 and each of the intake manifold 44 and the exhaust manifold 34. As shown in FIGS. 3 and 4, each gasket 10 includes a protrusion 26 that extends past the outer surface 32 of cylinder head 30 and past outer surface 35 of flange 36.

The extension of protrusion 26 past the outer surface of cylinder head 30 and the respective flange facilitates the positioning of gasket 10 during engine assembly. As shown in FIG. 4, engine 42 includes many components that are positioned on or around cylinder head 30. The close proximity of these components make positioning each gasket 10 relative to cylinder head 30 a difficult task. Protrusion 26, however, may be easily grasped to position each gasket 10. Each protrusion 26 may be grasped by a worker during a manual assembly process or by a robotic arm during an automated assembly process. Thus, the present invention simplifies the assembly of the engine 42.

In addition, protrusion 26 facilitates removal of the gasket 10 for maintenance purposes. During assembly and operation of engine 42, gasket 10 may adhere to the surface of cylinder head 30 or to the respective manifold flange. When engine 42 is disassembled for service or repair, the protrusion 26 may be grasped to generate the leverage required to remove the gasket 10 from cylinder head 30 or the respective manifold flange.

Gasket 10 of the present invention may also include a protective substance 25 that protects main body 12 of the gasket from damage due to exposure to high temperatures. In certain applications, such as when used to form a seal between cylinder head 30 and exhaust manifold 34, gasket 10 may be exposed to high temperature gas. Protective substance 25 is disposed along inner edge 17 and a portion of first and second sealing surfaces 22 and 24 of main body 12 to protect gasket 10 from being damaged by the high temperature gas flowing through opening 20. The protective substance 25 will reduce the amount of maintenance required and extend the life of gasket 10.

It will be apparent to those skilled in the art that various modifications and variations can be made in the engine gasket of the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims and their equivalents.

What is claimed is:

1. An engine gasket, comprising:
a main body having a first sealing surface, a second sealing surface, an inner edge defining an opening through the main body between the first and second sealing surfaces, and an outer edge; and
a protrusion having a preestablished configuration, said preestablished configuration being accessible after said first sealing surface and said second surface being adapted for sealing therebetween.

2. The gasket of claim 1, further including a protective substance covering a portion of the first and second sealing surfaces adjacent the inner edge;

3. The gasket of claim 1, wherein the inner edge of the main body includes at least one linear segment and the outer edge of the main body has at least one linear segment extending substantially parallel to the at least one linear segment of the inner edge.

4. The gasket of claim 3, wherein the opening defined by the inner edge has a substantially rectangular shape.

5. The gasket of claim 4, wherein the main body defines a plurality of openings, one of the plurality of openings disposed adjacent each of the corners of the inner edge.

6. The gasket of claim 3, wherein the inner edge includes a series of four linear segments connected by rounded segments.

7. The gasket of claim 6, wherein the outer edge includes three substantially linear segments, each of the three substantially linear segments extending substantially parallel to one of the series of four linear segments of the inner edge.

8. The gasket of claim 1, wherein the protrusion has a substantially triangular shape.

9. The gasket of claim 1, wherein the protrusion includes a first surface that substantially aligns with the first sealing surface of the main body and a second surface that substantially aligns with the second sealing surface of the main body.

10. A method of assembling an engine, comprising:
providing a cylinder head having an outer surface, at least one intake passageway, and at least one exhaust passageway;
providing at least one of an intake manifold having a flange and an exhaust manifold having a flange;
disposing at least one gasket having a protrusion between the cylinder head and the flange of the at least one of the intake manifold and the exhaust manifold, the protrusion having a preestablished configuration that is accessible after the at least one gasket is positioned between the cylinder head and the flange of the at least one of the intake manifold and the exhaust manifold; and
securing the flange of the at least one of the intake manifold and the exhaust manifold to the cylinder head.

11. The method of claim 10, further including:
providing the other of the intake manifold and the exhaust manifold;
disposing at least one gasket having a protrusion between the cylinder head and the flange of the other of the intake manifold and the exhaust manifold such that the protrusion extends past the outer surface of the cylinder head; and
securing the flange of the other of the intake manifold and the exhaust manifold to the cylinder head.

12. An engine, comprising:
a cylinder head having at least one intake passageway and at least one exhaust passageway;
an intake manifold having a flange with an outer surface, the intake manifold configured to engage the cylinder head adjacent the at least one intake passageway;
an exhaust manifold having a flange with an outer surface, the exhaust manifold configured to engage the cylinder head adjacent the at least one exhaust passageway; and
at least one gasket including a main body having an opening, a first sealing surface configured to engage the cylinder head, and a second sealing surface configured to engage one of the exhaust manifold and the intake manifold, the at least one gasket further including a protrusion having a preestablished configuration being accessible after the one of the intake manifold and the exhaust manifold is engaged with the cylinder head to seal the gasket therebetween.

13. The engine of claim 12, wherein the cylinder head includes an outer surface and the protrusion extends past the outer surface of the cylinder head when the one of the intake manifold and the exhaust manifold is engaged with the cylinder head.

14. The engine of claim 12, further including a first series of gaskets disposed between the cylinder head and the intake manifold and a second series of gaskets disposed between the cylinder head and the exhaust manifold.

15. The engine of claim 12, wherein the gasket includes an inner edge that defines the opening in the main body and has at least one linear segment.

16. The engine of claim 15, wherein the opening defined by the inner edge of the gasket has a substantially square shape.

17. The engine of claim 15, wherein the inner edge includes a series of four linear segments connected by a series of four rounded segments.

18. The engine of claim 17, wherein the gasket includes an outer edge having at least one linear segment extending substantially parallel to at least one of the four linear segments of the inner edge.

19. The engine of claim 18, wherein the outer edge includes three linear segments and each of the three linear segments extends substantially parallel of one of the four linear segments of the inner edge.

20. The engine of claim 12, wherein the one of the exhaust manifold and the intake manifold includes a flange having a plurality of openings and the main body of the gasket defines a plurality of openings configured to align with the plurality of openings in the flange of the one of the exhaust manifold and the intake manifold.

21. The engine of claim 12, wherein the protrusion has a substantially triangular shape.

22. The engine of claim 12, wherein the protrusion includes a first surface that substantially aligns with the first sealing surface of the main body of the gasket and a second surface that substantially aligns with the second sealing surface of the main body of the gasket.

23. An engine gasket for sealing engagement between engine components, comprising:
a main body having a first sealing surface, a second sealing surface, an inner edge defining an opening through the main body between the first and second sealing surfaces, and an outer edge; and
a means for positioning the main body of the gasket relative to the engine components.

24. The engine gasket of claim 23, further including a protective substance covering a portion of the inner edge.
